(19) United States
(12) Patent Application Publication
(10) Pub. No.: US 2008/0272105 A1
(43) Pub. Date: Nov. 6, 2008

(54) Soldering Device With Computer-Based Sensor System

(76) Inventors: Eugen Weissenberger, Eussenheim (DE); Thomas Alletzhauser, Wertheim-Dorlesberg (DE); Hans Molzer, Hardheim (DE); Georg Konig, Wertheim-Mondfeld (DE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 12/093,546

(22) PCT Filed: Oct. 9, 2006
(86) PCT No.: PCT/DE2006/001769

§ 371 Date: May 13, 2008

(30) Foreign Application Priority Data
Nov. 14, 2005 (DE) 10 2005 054 521.1

(51) Int. Cl. H05B 1/00

(52) U.S. Cl. 219/209

(57) ABSTRACT

The invention pertains to a soldering device (01) for soldering work pieces, wherein said soldering device (01) features at least one heating element (06), at least two heating current supply lines (07, 08) and at least one sensor (05, 06, 07, 08, 09, 10, 11, 13), wherein the heating element can be supplied with a heating current via the heating current supply lines (07, 08), wherein the soldering device (01) features a computer unit (12), and wherein the sensor (05, 06, 07, 08, 09, 10, 11, 13) is connected to the computer unit (12).

The invention pertains to a soldering device for soldering work pieces according to the preamble of the main claim.

Soldering devices of the generic type frequently are difficult to control with respect to their heating power. One problem consists of determining all ambient conditions by means of sensors because simple options for determining all ambient conditions are frequently not available. Even if these options are available, one frequently encounters the problem of finding a simple solution for leading the connections of the sensors out of the soldering device and to a control unit.

The present invention is based on the objective of proposing a novel soldering device.

According to the present invention, this objective is attained with the characteristics of the main claim.

Advantageous embodiments of the invention form the objects of the dependent claims.

The objective of the invention is attained in that the soldering device for soldering work pieces features at least one heating element, at least two heating current supply lines and at least one sensor, wherein the heating element can be supplied with a heating current via the heating current supply lines, and wherein the soldering device features a computer unit, wherein the sensor is connected to the computer unit.

The soldering device may essentially be realized arbitrarily. It may consist of a soldering iron designed for being connected to a control unit or, for example, an autarkic handheld soldering iron.

The heating element also may essentially be realized arbitrarily. The heating element serves for heating the soldering tip and is supplied with a current via the two heating current supply lines.

The soldering device may furthermore feature at least one sensor. The sensor can measure any physical parameters, particularly a temperature. It is particularly advantageous to control the heating current for the heating element based on these measurements.

However, it frequently does not suffice to base the control of the heating current on the measurement of a single sensor. It would be advantageous, for example, to measure the temperature at different locations within the soldering device. It would be possible, for example, to measure the temperature at the soldering tip, the temperature of the heating element or even the temperature in the region of the handle of the soldering device. It would even be conceivable to provide a sensor in the form of an identification sensor that provides the soldering device with a distinct identification feature.

The readout of the sensors is usually carried out by a control device that may be situated inside or outside of the soldering device. If the sensors are locally spaced apart from the control device by a significant distance, a plurality of connecting lines between the sensors and the control device is required if a multitude of sensors is provided.

It is also known to assign a transducer component to each sensor and to bundle the supply lines leading to the sensors in accordance with the One Wire principle. However, this not only requires numerous transducer components, but also special sensors or actuators, respectively. These special sensors or actuators have the disadvantage that they are very inflexible with respect to their function and also expensive with respect to their manufacture and procurement.

The inventive soldering device features a computer unit, wherein the sensor or the sensors is or are connected to the computer unit. This means that the supply lines of the sensors can be realized relatively short. The further connection to the control unit is produced between the computer unit and the control unit. This connection is usually realized with a manageable number of only a few supply lines.

The sensors are indirectly read out by the computer unit. This makes it possible, if so required, to prompt the computer unit to produce the connection to a certain sensor. The measurement can then be carried out by the computer unit and the determined measured value can be forwarded, for example, to the control unit, wherein it would also be possible, for example, to connect the sensor to the connecting line leading from the computer unit to the control unit.

This means that a plurality of measured values is available with a minimal number of connecting lines. This provides maximum flexibility and only requires minimal wiring expenditure.

It is also possible to expand the sensor arrangement of the soldering device, for example, by adding another sensor, with minimal installation expenditure. In this case, it is merely required to connect the additional sensor to the computer unit.

A digital connection of several soldering devices, for example, in a bus system can also be easily realized.

In addition, the combined forwarding of the sensor information from the computer unit, for example, to the control unit has positive effects on the diameter and the weight of this connecting line between the computer unit and, for example, the control unit. The handle region of a soldering device and the size of plug-type connectors can also be realized in a more slender fashion. In addition, the data transmission is less susceptible to errors because the electromagnetic interactions between the sensor connecting lines are reduced.

The computer unit may essentially be realized arbitrarily. In one particular embodiment, the computer unit is realized in the form of a microcontroller. This provides the particular advantage of a flexible adaptation of the computer unit that is also able to carry out computations in this case.

This embodiment furthermore provides the advantage that separate transducer components for bundling the sensor data can be largely eliminated. The system becomes more cost-efficient and more flexible with respect to its design, realization and expandability.

The type of communication with the computer unit may essentially be realized arbitrarily. However, it is particularly advantageous if the computer unit is connected to at least two computer unit supply lines, wherein at least one computer unit supply line is identical to at least one heating current supply line, and wherein the communication with the computer unit can be realized via the computer unit supply lines. In this case, it is possible, for example, to externally access the computer unit within the soldering device. In this case, the connection of a soldering device, for example, to a control unit is realized via one of the heating current supply lines and one other supply line only. Additional supply lines are not required in this case. The connecting line for connecting the soldering device, for example, to a control device can have a very small diameter. The flexibility of such a line is also advantageously affected. The connectors of the connecting lines can also be realized with smaller dimensions. The potentials of the heating element and the computer unit can furthermore be decoupled due to the additional computer unit supply line.

It may also prove advantageous to connect the computer unit to two separate computer unit supply lines that are respectively not identical to one of the heating current supply lines. For example, other interferences between the heating element and the computer unit can be avoided in this case.

However, it would also be possible that the computer unit supply lines and the heating current lines are identical in pairs. In this case, only the heating current supply lines are required for realizing the external connections of the heating element and the computer unit.

The communication with the computer unit via the computer unit supply lines may essentially be realized arbitrarily. The communication with a digital transmission protocol is particularly advantageous. Such a transmission usually takes place in a serial fashion. In this case, an inquiry regarding a certain sensor is initially sent to the computer unit and the computer unit then ensures the interrogation of the desired sensor.

The interrogation may be realized, for example, in such a way that the computer unit forwards the measured value to an external unit or simply ensures that the desired sensor can be accessed via the computer unit supply lines.

In another advantageous embodiment, the computer unit is connected to the computer unit supply lines in accordance with the One Wire principle. In this case, the computer unit supply lines not only serve for the voltage supply of the computer unit, but also for the bidirectional communication with the computer unit. In this embodiment, communication lines and supply lines leading to the computer unit are combined with one another.

In another advantageous embodiment, the computer unit supply lines of the soldering device can be connected to a control unit, wherein the control unit can communicate with the computer unit of the soldering device via the computer unit supply lines.

In this embodiment, the control unit is not only responsible for supplying the soldering device with a heating current, but also for controlling the heating current, for example, in order to protect the components of the soldering device. In order to ensure a reliable control by means of the control unit, the control unit relies on the data of sensors in the soldering device.

In the proposed connection by means of the computer unit supply lines, the control unit sends an interrogation command to the computer unit in the soldering device and thusly prompts the computer unit to address the corresponding sensor. The control unit in response receives, for example, the measured value of the sensor or is granted access to the sensor.

In another advantageous embodiment, at least one thermal element is formed between the heating element and the heating current supply lines, wherein at least one thermal voltage can be tapped on said thermal element.

However, this combination of characteristics is not only effective in connection with this invention. The realization of a heating element based on this combination of characteristics alone provides the same advantage. This combination of characteristics does not necessarily have to be realized in connection with a soldering device. Heating elements as such that feature these characteristics also prove advantageous. Heating elements of this type can be used, for example, in coffee machines and in plastic injection-molding tools.

Such a heating element may also be advantageous in a soldering device. The soldering device consists, for example, of a soldering device for soldering work pieces, wherein the soldering device features at least one heating element and at least two heating current supply lines, wherein the heating element can be supplied with a heating current via the heating current supply lines, and wherein at least one thermal element, on which at least one thermal voltage can be tapped, is formed between the heating element and the heating current supply lines.

The temperature of the elements forming the thermal element can be determined based on the effect of the thermal voltage. The thermal element is formed of the heating element and the heating current supply lines as proposed in this application. The heating element and the heating current supply lines are in particular need of protection. For example, modern heating elements of soldering devices become increasingly smaller and more powerful. If the soldering device is operated incorrectly or if the mass to be heated is missing, for example, when the soldering tip is removed, the heating element may become overloaded and subsequently destroyed. Thus it is particularly important to monitor the temperature of the heating element. However, since the temperature of the heating element does not necessarily correspond to the temperature in the soldering tip, the temperature of the heating element should be determined directly on or even better in the heating element itself. One particularly suitable option for realizing this is the thermal effect.

For example, if a soldering tip of the soldering device is removed during the operation of the soldering device, the energy of the heating element can no longer be released outward. In this case, there is the risk that the heating element may burn out and thusly be destroyed. The temperature of the heating element rises. However, the thermal voltage on the thermal element formed by the heating element and the heating current supply lines also increases with the rising temperature. In the control of the heating current, for example, by means of the control device, it is therefore possible to determine the temperature of the heating element and to decrease the heating current accordingly if the temperature of the heating element rises.

However, this temperature measurement initially serves for determining the temperature of the heating element only. The temperature of the actual soldering tip is usually determined by means of a separate temperature sensor.

Another advantage of forming the thermal element between the heating element and the heating current supply lines can be seen in that no costly additional installations are required. In this case, it is merely required to manufacture the elements that form part of the thermal element of suitable metallic materials.

The heating element and the heating current supply lines may essentially be realized arbitrarily. In one particularly advantageous embodiment, the heating element consists of a first metallic material, the first heating supply line consists of a second metallic material and the second heating current supply line consists of a third metallic material. This allows a particularly flexible manufacture and also a simple retrofitting of the thermal element.

The same effects can be achieved in an even simpler fashion if only the ends of a heating spiral forming the heating element are provided with a metallic material that forms part of the thermal element.

The heating element itself or only the ends of a heating spiral forming the heating element may consist, for example, of a NiCr-alloy. The first heating current supply line may consist, for example, of a nickel wire and the second heating current supply line may consist of an iron wire in this case.

It would also be possible, for example, to use combinations of platinum, platinum-rhodium, constantan and/or copper and/or other alloys or metallic materials suitable for forming a thermal element.

This thermal element that acts as a temperature sensor may essentially be operated in an analogous fashion. This would require that a voltage measurement be carried out between the heating wires. This voltage measurement may take place, for example, within the soldering device, but may also be realized, for example, by means of a control unit, to which the soldering device is connected with its heating current supply lines.

In another advantageous embodiment, the thermal element can be connected to the computer unit in the form of a sensor. This provides a simple option for measuring the temperature of the heating element without a noteworthy increase in the installation expenditure. In this case, the computer unit determines, for example, the voltage between the heating current supply lines or enables, for example, a control device to measure the voltage between the heating current supply lines.

In another advantageous embodiment, the soldering device features a sensor for detecting the use and/or a movement of the soldering device.

This characteristic, however, is not only effective in connection with the present invention, but also produces its effect in an autonomous invention.

A sensor of this type is able to detect the use and/or a movement of the soldering device or if the soldering device is in an idle phase. This sensor output can be used, for example, for detecting the use of the soldering device. This is possible because soldering devices are usually displaced during the soldering process, particularly when they are moved toward the soldering point or away from the soldering point. During the idle times, while the soldering device is not moved, for example the heating current supply can be interrupted. The soldering device is then switched into a stand-by mode.

This not only protects, in particular, the participating components such as, for example, the heating element and the soldering tip, but also reduces the energy consumption. In addition, this type of detecting a movement or the use of the soldering device is maintenance-free and contactless. Solutions known so far were dependent, for example, on additional mechanical and/or electrical or electromechanical attachments. This was realized, for example, in the form of electrical connections between the soldering device and the holding stand. These solutions furthermore required high expenditure with respect to the routing of electrical lines, the mechanical devices for accommodating sensors and actuators, as well as their control and evaluation. Due to this system configuration, the reliability of the function also was frequently limited in solutions of this type.

The sensor for detecting the use and/or a movement of the soldering device may essentially be realized arbitrarily. In one particularly preferred embodiment, however, the sensor is realized in the form of an acceleration sensor. This allows a simple and cost-efficient detection of a movement or the use of a soldering device. Sensors of this type can be inexpensively purchased in the form of accessory components and can also be easily evaluated.

In another advantageous embodiment, the sensor is realized in the form of a proximity sensor. For example, if a human hand approaches the soldering device, it can usually be assumed that the use thereof is imminent, wherein the removal of the human hand in all likelihood indicates that the soldering iron was put down.

The proposed motion detection is not necessarily dependent on a connection to the inventive computer-based sensor system, but may also be implemented in a soldering device in the form of an analogous independent solution. In such an instance, the motion sensor is directly accessed.

However, it would also be conceivable to connect the motion sensor to the computer unit. The above-described advantageous effects are achieved in this case.

The measuring data of the sensor for detecting the use and/or a movement of the soldering device may essentially be evaluated arbitrarily. It is advantageous to record the movement of the soldering device in a virtual coordinate system. This may be realized based on the data of the sensor for detecting the use and/or a movement of the soldering device.

Soldering devices of this type frequently are also used in robotic systems. In this case, it would be possible to record the two-dimensional or three-dimensional motion curve in order to reproduce the moving path of the soldering tip.

In another advantageous embodiment, the motion curve is recorded for archiving and control purposes together with the respective soldering tip temperatures determined at the individual points of the motion curve and the correlating times.

The soldering tips to be attached to the soldering device should be optimally adapted to the heating element geometry with respect to their shape and mass in order to protect the soldering device and to ensure the troublefree operation thereof. An optimal thermal coupling between the heating element and the soldering tip should be achieved, in particular, in order to protect the heating element.

The inside diameter and the internal geometry of the soldering tips, as well as their outside diameter, external geometry and overall length, should be ideally adapted to the geometry and length of the heating element.

One embodiment of the invention is illustrated in the drawing and is described in an exemplary fashion below.

In this drawing,

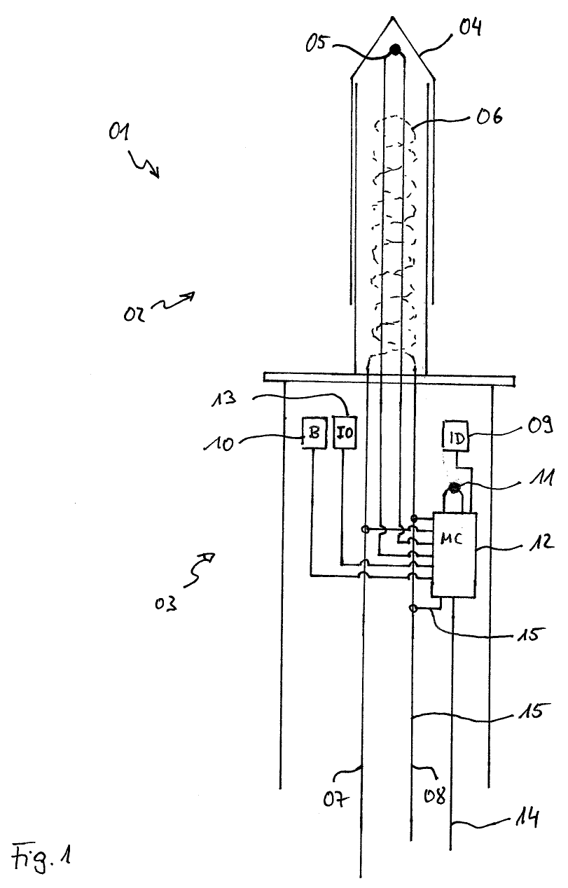

FIG. 1 shows a schematic representation of a soldering device that is realized in the form of a handheld soldering iron.

FIG. 1 shows a handheld soldering iron with a functional section 02 and a handle section 03. A soldering tip 04 is positively fitted over the functional section 02. This positive fit results in an optimal thermal coupling between the functional section 02 and the soldering tip 04.

The functional section 02 furthermore features a soldering tip temperature sensor 05. The soldering tip temperature sensor 05 determines the temperature at the soldering tip.

The functional section 02 furthermore features a heating element 06. The heating element 06 is realized in the form of a bifilar heating wire that consists of a NiCr-alloy.

The two respective connections of the soldering tip temperature sensor 05 and of the heating element 06 extend into the handle section 03.

Two heating current supply lines 07, 08 situated within the handle section 03 are connected to one respective end of the heating element 06. The first heating current supply line 07 consists of a nickel wire and the second heating current supply line 08 consists of an iron wire. The second end of the heating current supply lines respectively extends out of the handheld soldering iron 01. Due to the three different metallic materials of the heating element 06 of the first heating current supply line 07 and the second heating current supply line 08, a thermal element is formed of the heating element and the two heating current supply lines. This makes it possible to determine the temperature of the heating wire itself based on the thermal effect.

The handle section 03 furthermore contains an identification sensor 09. The identification sensor 09 represents a distinct identification feature that makes it possible to identify the handheld soldering iron 01.

The handle section 03 furthermore contains an IO transducer component 13, by means of which additional sensors and/or actuators can be connected in accordance with a conventional principle.

In addition, the handle section 03 also contains a use sensor 10. The use sensor 10 makes it possible to detect a motion of the handheld soldering iron 01. When the soldering iron is not in use, the heating current supply can be shut off via the heating current supply lines 07, 08.

In addition, the handle section 03 also contains a handle section temperature sensor 11. The handle section temperature sensor 11 makes it possible to determine the temperature within the handle section 03. This makes it possible, for example, to prevent the operator from being injured.

The connecting lines of the sensors 05, 06, 07, 08, 09, 10, 11 and 13 are connected to the input side of a computer unit 12 integrated into the handheld soldering iron 01 along the shortest route possible. The computer unit 12 is realized in the form of a microcontroller in this case. The output side of the computer unit 12 in turn is connected to the computer unit supply lines 14 and 15. This enables, for example, an external control unit to communicate with the computer unit 12.

In this embodiment, the heating current supply line 08 and the computer unit supply line 15 are identical. Consequently, the expenditure of the wiring out of the handheld soldering iron 01 is limited to the two heating current supply lines 07 and 08 and the additional computer unit supply line 14.

However, the computer unit supply lines may respectively extend out of the soldering device separately, for example, without being identical to one of the heating current supply lines. This results in the advantages that have already been described above.

The complete connecting line between the handheld soldering iron 01 and another device therefore is realized in a particularly simple and uncomplicated fashion.

1. A soldering device for soldering work pieces, wherein said soldering device features at least one heating element, at least two heating current supply lines and at least one sensor, and wherein the heating element can be supplied with a heating current via the heating current supply lines,
wherein
the soldering device features a computer unit, wherein the sensor is connected to the computer unit.

2. The soldering device according to claim 1, wherein the computer unit is in the form of a microcontroller.

3. The soldering device according to claim 1, wherein
the computer unit is connected to at least two computer unit supply lines, wherein at least one computer unit supply line is identical to at least one heating current supply line, and wherein it is possible to communicate with the computer unit via the computer unit supply lines.

4. The soldering device according to claim 1, wherein
the computer unit is connected to the computer unit supply lines in accordance with the One Wire principle, wherein the computer unit supply lines serve for supplying the computer unit, and wherein the computer unit supply lines also serve for the bidirectional communication with the computer unit.

5. The soldering device according to claim 1, wherein
the computer unit supply lines of the soldering device can be connected to a control unit, wherein the control unit is able to communicate with the computer unit of the soldering device via the computer unit supply lines.

6. The soldering device according to claim 1, wherein
at least one thermal element, on which at least one thermal voltage can be tapped, is formed between the heating element and the heating current supply lines.

7. The soldering device according to claim 1, wherein
the heating element consists of a first metallic material, the first heating current supply line consists of a second metallic material and the second heating current supply line consists of a third metallic material.

8. The soldering device according to claim 6, wherein
the thermal element can be connected to the computer unit in the form of a sensor.

9. The soldering device according to claim 1, wherein
the soldering device features a sensor for detecting the use and/or a movement of the soldering device.

10. The soldering device according to claim 9, wherein
the sensor for detecting the use and/or a movement of the soldering device is realized in the form of an acceleration sensor.

11. The soldering device according to claim 9, wherein
a multidimensional motion curve is defined at least by the sensor for detecting the use and/or a movement of the soldering device.

12. The soldering device according to claim 9, wherein
the motion curve is recorded together with a correlating temperature and a correlating time.
